(19) United States
(12) Patent Application Publication
(10) Pub. No.: US 2022/0000042 A1
(43) Pub. Date: Jan. 6, 2022

(54) UNITARY PLANT SHELF

(71) Applicant: Daniel S. Spiro, Scottsdale, AZ (US)

(72) Inventor: Daniel S. Spiro, Scottsdale, AZ (US)

(21) Appl. No.: 17/478,626

(22) Filed: Sep. 17, 2021

Related U.S. Application Data
(63) Continuation-in-part of application No. 16/805,093, filed on Feb. 28, 2020.
Application No. 16/805,093 is a continuation-in-part of application No. 16/202,821, filed on Nov. 28, 2018, now Pat. No. 11,122,748.
Application No. 16/202,821 is a continuation-in-part of application No. 16/202,821, filed on Nov. 28, 2018, now Pat. No. 11,122,748.
(60) Provisional application No. 62/592,246, filed on Nov. 29, 2017.

(51) Int. Cl. A01G 9/02

(52) U.S. Cl. CPC A01G 9/023; A01G 9/025

(57) ABSTRACT

A modular vertical cultivation wall system includes at least two vertical posts, at least one planter shelf including a planter flange and a planter web, and a plurality of wall panels. Each of the at least two vertical posts may be anchored and may include a post web and at least one post flange coupled thereto. The at least one planter shelf may be coupled to one of a plurality of wall panels, and is horizontally disposed. The at least one planter shelf may extend between the at least two vertical posts. At least one of the plurality of wall panels may be disposed above and coupled to another one of the plurality of wall panels, and at least one of the planter flange and the planter web may be coupled to at least one of: the post web and the at least one post flange.

### CROSS-REFERENCE TO RELATED APPLICATIONS

The present disclosure is a continuation-in-part of co-pending U.S. application Ser. No. 16/805,093, filed Jan. 23, 2020, which is a continuation-in-part of co-pending U.S. application Ser. No. 16/202,821, filed Nov. 28, 2018, which claims benefit from U.S. Provisional Application No. 62/592,246, filed Nov. 29, 2017; and the subject application is a continuation-in-part of co-pending U.S. application Ser. No. 16/202,821, filed Nov. 28, 2018. The disclosures of the above-referenced applications are hereby incorporated by reference in their entirety.

### TECHNICAL FIELD

The present disclosure is generally related to a module vertical cultivation system.

### BACKGROUND

Traditional wall panels, without or without planter shelves, can be less amenable to fabrication, or to an effective construction process. An amount of material used in traditional wall panels can make using fabrication processes cost-prohibitive, can require extended production time, and/or can incur high shipping costs. Traditional wall panels may also have limited utility and can be difficult to adapt to different applications.

### SUMMARY

According to an aspect of the present disclosure, a modular vertical cultivation wall system includes at least two vertical posts, at least one planter shelf including a planter flange and a planter web, and a plurality of wall panels. Each of the at least two vertical posts may be anchored and may include a post web and at least one post flange coupled thereto. The at least one planter shelf may be coupled to one of a plurality of wall panels, and is horizontally disposed. The at least one planter shelf may extend between the at least two vertical posts. At least one of the plurality of wall panels may be disposed above and coupled to another one of the plurality of wall panels, and at least one of the planter flange and the planter web may be coupled to at least one of: the post web and the at least one post flange.

In some embodiments, the system of the present disclosure may include a continuous power conductor including at least one lighting source coupled to the at least one planter shelf. In some embodiments, the system of the present disclosure may include a high tensile strength reinforcement member coupled to the planter flange. In some embodiments, a mounting height of the at least one planter shelf may be adjustable along a vertical height of at least one of: the post web and the at least one post flange.

In some embodiments, at least one of: one of the at least two vertical posts, the at least one planter shelf, and a first wall panel of the plurality may be coupled to at least one of: a fluid conveyance device, a power generating device, a sensing device, a communication device, an output device, and an input device. In some embodiments, a wall panel enclosure may be coupled to the at least one planter shelf, wherein the enclosure may be configured to receive at least one of: a gas, a liquid, and a solid material.

In some embodiments, a chase post may include at least two chase post webs, at least two chase post flanges extending outward from one side of the chase post web, and an access panel. The chase post may be configured to house at least one of: a fluid storage device, a fluid circulation device, and an electrical power consuming device.

In some embodiments, at least one of the plurality of wall panels may be configured to attenuate sound transmission by at least one of: material fill inside the wall and vacuum seal of the wall interior. The at least one of the plurality of wall panels may be coupled to the at least one planter shelf and may be coupled to and disposed above and/or below another one of the plurality of wall panels.

In some embodiments, at least one mechanical fastening device may couple the planter flange and/or the planter web to the at least one post flange and/or the post web. In some embodiments, a fluid irrigation pipe may extend along a length of the planter shelf coupled to at least one of: the inside, top or bottom of a planter channel, and to the wall panel.

According to another aspect of the present disclosure, a modular vertical cultivation wall system includes at least two vertical posts, at least one planter shelf, and a plurality of wall panels. Each of the vertical posts may be anchored using at least one post web and one post flange. Each post web and post flange may be unitarily coupled. At least one planter shelf may be unitarily coupled to a wall panel. The at least one planter shelf unitarily coupled to the wall panel may be horizontally disposed. Each end of the at least one planter shelf may extend between the post flanges. One of a plurality of wall panels may be coupled from above to another one of the plurality of wall panels. A second wall panel may be coupled from below to the same wall panel with the unitarily coupled a planter shelf. A planter web and/or a planter flange of the planter shelf may be coupled to at least one support bracket and, the support bracket may be coupled to at least one of: the post flange and the post web.

In some embodiments, the system of the present disclosure may include a continuous power conductor including at least one lighting source coupled to the at least one planter shelf. In some embodiment, the system of the present disclosure may include a high tensile strength reinforcement member coupled to the planter flange. In some embodiments, a mounting height of the at least one planter shelf may be adjustable along a vertical height of at least one of: the post web and the post flange.

In some embodiments, at least one of the post and the at least one planter shelf may be coupled to at least one of a power generating device, a sensing device, a communication device, an output device, and an input device. In some embodiments, a wall panel enclosure may be unitarily coupled to the planter shelf, wherein the enclosure may be configured to receive at least one of: a gas, a liquid, a solid and a vacuum.

In some embodiments, a chase post may include at least two chase post webs, at least two chase post flanges extending outward from one side of the chase post web, and an access panel. The chase post may be configured to house at least one of: a fluid storage device, a fluid circulation device, and an electrical power consuming device.

In some embodiments, at least one of the plurality of wall panels may be configured to attenuate sound transmission. In some embodiments, at least one wall panel unitarily coupled to a planter shelf may be coupled to and disposed above and/or below a wall panel. In some embodiments, a plant matrix may be disposed on the web of the planter shelf. In some embodiments, the fluid flowing through a fluid irrigation pipe that may extend along a length of a planter channel and across the post web to at least one additional planter shelf.

### BRIEF DESCRIPTION OF FIGURES

The detailed description particularly refers to the following figures, in which:

FIGS. 1A and 1B show a transverse and a partial longitudinal section of the planter shelf with a planter channel coupled unitarily to a wall panel;

FIGS. 2A and 2B show a transverse and a partial longitudinal section of the planter shelf end in proximity to a post web;

FIGS. 3A and 3B show a transverse and a partial longitudinal section of the planter shelf with a planter channel coupled unitarily to a wall panel with plant material;

FIGS. 4A and 4B show an elevation view and a traverse section view of an exemplary cultivation wall with the planter shelf configured to retain plants in a web channel;

FIGS. 5A and 5B show perspectives from front and back of the vertical cultivation wall system comprising posts and plant shelves unitarily coupled to wall panels; and

FIGS. 6A-6C show diagrammatic views of the vertical cultivation system fluid circulatory system and electrical power circulation network of coupled devices.

### DETAILED DESCRIPTION

While the concepts of the present disclosure are susceptible to various modifications and alternative forms, specific exemplary embodiments are been shown by way of example in the drawings and will be described. It should be understood, however, that there is no intent to limit the concepts of the present disclosure to the particular forms disclosed; on the contrary, the intention is to cover all modifications, equivalents, and alternatives falling within the spirit and scope of the invention as defined by the appended claims.

References in the specification to “one embodiment,” “an embodiment,” “an illustrative embodiment,” etc., indicate that the described embodiment may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

An example vertical plant cultivation wall system includes posts with at least one of: a horizontal planter shelf and a wall panel disposed side by side wedged between post flanges and together forming a vertical cultivation wall.

The example vertical plant cultivation wall system of the present disclosure is configured to couple the planter shelf unitarily to a wall panel. Unitarily coupling a planter shelf to a wall panel simplifies the fabrication of the cultivation system and the construction process. The planter shelf can be coupled to one side of the wall panel or both sides.

The newly formed planter shelf coupled to a wall panel reduces the material usage in fabrication, production time, and shipping costs. It also simplifies the system's electrical and fluid circulation while expanding on the system's utility.

The system can includes a planter shelf coupled unitarily to a wall panel and vertical support posts, where the planter shelf may extend between two flanged vertical posts. Support brackets coupled to the vertical posts may be used to support each end of to the planter shelf.

The Planter Shelf—The planter shelf is unitarily coupled to a wall panel. Together the planter shelf and the wall panel form an elongated body that is configured to be disposed horizontally between at least two flanges of anchored posts vertically positioned at both ends of the planter shelf. The shelf and its contents, coupled to a wall panel, can be supported by at least one of: a wall panel below, a bracket coupled to the planter shelf, and a post having at least one web and a flange, or a combination thereof.

The elongated shelf has a web that is configured to retain plant material. The plant material is disposed on the web from one end post to another at the opposite side of the elongated shelf. The web on one side couples unitarily to a wall panel. At the other longitudinal side, the web couples to at least one flange that perpendicularly extends upward or upward and downward direction/s.

The planter shelf profile is in the form of the letter “U” derived by the planter's web at the base unitarily coupled to a walled panel on one side and the planter shelf flange on the other side. The continuous “U” shaped elongated channel is referred to herein as the shelf channel. Inside the shelf channel, plant root retaining material is disposed on the shelf channel's web. The plant root retaining material referred herein as the plant's matrix can be seeded or delivered with plants. The planter channel web can have at least one weep hole to remove excess fluid from the channel.

The planter shelf can have bores at both ends. These bores are configured for coupling the shelf to the post's flanges. Coupling the planter shelf to the post's flanges secures the shelf against rotation and prevents shelf deflection. In addition, the shelf's channel can be supported by brackets. The support brackets are coupled to at least one of: a surface of the post's web and the post's web and on the other surface to at least one of: a shelf's flange, the shelf's web and the shelf's flange.

In another embodiment, the shelf's channel originating at the wall panel is cantilevered outwardly supported or un-supported by the posts' flanges and/or supported by the post web coupled brackets. In yet another embodiment, a continuous bracket or segmented brackets disposed below the planter shelf's web and coupled to at least one of: a wall panel and the bottom side of the planter shelf web can provide additional structural support to the planter shelf (not shown). In addition, reinforcement stiffeners can be incrementally coupled or unitarily formed inside the shelf channel (not shown).

In both fixed and cantilevered configurations described above, at least one elongated reinforcement element having high tensile strength can be embedded inside the planter's shelf flange and/or affixed to the flange.

The Wall Panel—The wall panel is an elongated vertical enclosure. The enclosure can be solid, hollow filled with infill material, or empty. A hollow enclosure can be voided of air in a vacuum state. A vacuum state wall panel reduces sound transmission by denying sound a medium to propagate through. In another embodiment, a hollowed enclosure can be filled with material including at least one of: solids, liquids, and gases. Infill material is commonly used with sound attenuation walls. The wall panels can be made of metallic or nonmetallic material.

The wall panel top, bottom or top and bottom surfaces may be keyed. The key is configured to interlock one wall panel and another wall panel, where one wall panel is disposed over another wall panel. The wall panel may be unitarily coupled to a planter shelf or not. This means of mechanical locking provides a panel alignment and a restraint against lateral movement. The mechanical key may also provide more surface area for structural support for the wall panels disposed over one other.

The weight of the wall panel with at least one unitary planter shelf can be supported in part by one of: a wall panel below, a post support bracket, and a combination of both. The wall panel is disposed between posts and wedged between two of the posts' flanges at each end. The wall panel can be fabricated with or without unitarily coupled planter shelf/shelves. For example, a vertical cultivation wall may have a 12″ high wall panel with a unitary planter shelf having an 8″ high planter shelf flange disposed below and coupled to a 12″ high wall panel above that has no unitarily coupled planter shelf. This module can repeat itself or come with a variety of configurations of panel height to form the wall assembly.

This innovation's planter shelf is unitarily coupled to a wall panel. The wall panel assembly from the top going down includes a header panel, a standalone wall panel, a planter shelf unitarily coupled to a wall panel, and a base panel. The header panel is an enclosure configured to rest on the top wall panel assembly securing the assembly from uplift forces. The header panel's width and height are customizable, configured to be coupled to the wall panel system below as described above. The header panel's enclosure can house electrical and/or mechanical devices. It also can store irrigation fluid.

The enclosure, at least in part, can be configured to convey electrical power and/or fluid to and from the header panel to other coupled and/or remote elements of the vertical plant cultivation wall system. As with the other wall panel types, the bottom face of the header panel can be keyed. The header panel exterior surface can retain a plurality of mechanical and electrical devices. The electrical devices can include at least one of: a power generating photovoltaic panel, a camera, a temperature/humidity sensor, and a communication device.

The panels below the header panel are comprised of a combination between the standalone wall panel and the planter shelf wall panel unitarily coupled to a wall panel discussed above. The bottom panel, regardless of the type, can rest on the terrain or more commonly rest on a base panel.

The base panel top surface can be keyed to receive at least in part the weight of the wall assembly from above, and distribute the weight to the surface below. The base panel can be hollow configured to convey power, power and data, and/or fluid to and from coupled neighboring wall system sections. The base panel can also store irrigation fluid.

The wall panel system can be fabricated of metallic or non-metallic material, new and/or recycled. At least one of the wall panel types can store and convey fluid. At least one electronic and/or mechanical device can be coupled to at least one of the wall panel types. At least one electronic device power can be conveyed through at least one type of the wall panels. The wall panels' dimensional size is customizable and so is the dimensional size of the planter shelf.

The Post and the Chase Post—The present innovation's posts are anchored to a foundation and/or embedded in the ground. Each post has at least one web. The chase post can have at least two webs. The chase post is an enclosure that retains at least one of: a fluid circulation device, a fluid storage device, a fluid filtration device, a processor, a controller, a back-up power supply, a switching device, a transceiver device, a busway, a receptacle, and grounding device.

In the present embodiment, fluid and power/data circulation originate from inside the chase post, and are conveyed across the chase web to the wall panels. The post and the chase post have at least two flanges at the same side of the web. The flanges are coupled to the web and are disposed perpendicularly to the vertically disposed post webs. A post web and/or at least one of the post's flanges can have a plurality of bores configured to be mechanically coupled to at least one of: a planter shelf flange, a planter shelf web, and a planter support bracket. The post can be made of metallic or nonmetallic material.

The post and/or the chase post flanges retain the wall panels and the wall panels that are unitarily couple to planter shelves vertically aligned. The panels are wedged between the post flanges abutting the post's web on both ends. The planter shelf with its unitarily coupled wall panel can be mechanically secured to at least one of: the post's web, the post's flange, and a support bracket.

The Support Bracket—The planter shelf web and/or the flange can be secured to a support bracket. The bracket is then secured to the post's web and/or flange. The means of securing the planter shelf is by common industrial bolts; however, other means not described herein can be used. The bracket can be fabricated in part or in whole of non-metallic material. The wall panels can also be supported by brackets. Brackets supporting wall panels are coupled to the wall panels' ends and to the post's web. Such brackets are primarily used to resist wall panel bowing under wind loads.

The Irrigation System—The present innovation's planter shelf is a continuous planter channel. A plant root retaining matrix can be disposed inside the planter channel on the planter channel web in between the wall panel and the planter channel's flange.

Fluid to the plant cultivation wall system can be conveyed from a remote location, can be stored inside at least one type of a wall panel, and/or can be delivered directly to plants through a network of fluid circulation pipes. The fluid is typically delivered under pressure; however, stored fluid can be distributed under gravity flow.

In the present embodiment, the fluid is delivered inside the chase post. The fluid can then continue to flow through the planter irrigation pipe to the tributary plant pipe or be stored in a mixing tank inside the chase. The fluid can be stripped of harmful elements and contaminates before being distributed. The fluid can also be irradiated by UV light. An electrical pump operated by a processor's controller can distribute the fluid through the irrigation system network as well as mix plant nutrient and pest control additives in the mixing tank. The processor with resident code and memory can be dedicated to the cultivation system or can operate all electrically power consuming devices coupled to the vertical plant cultivation wall.

In the present embodiment the irrigation pipes originating at the chase post emerge through the chase post web above the plant matrix coupled to the wall panel. The irrigation pipe extends the length of the panel and can extend across the post webs to other wall sections. Plant pipes disposed at repeated modules couple to the irrigation pipes. These pipes can emit fluid directly onto the plant matrix disposed inside the plant channel. In a different embodiment, drip irrigation emitters can be coupled directly to the irrigation pipe or to the nozzle of the plant pipe (not shown). The drip emitters minimize fluid usage. To attain maximum fluid conservation, a drip irrigation emitter can be configured to operate in response to input received at the processor from a moisture probe embedded in the root retaining matrix.

The fluid emitted is absorbed by the matrix irrigating the plant's root. Weep holes disposed on the web channel and spaced apart remove excess fluid. The base panel can receive fluid dripped down from all the above weep holes. The fluid collected can be returned to the chase post to be filtered and recycled (not shown).

The matrix can be delivered to the cultivation wall site plant and/or seed-free or with seeded matrix or grown. The matrix can be formed of material that retains its geometric form throughout the useful life of the matrix. The matrix can be delivered having plant nutrient, pest control substance, or a combination of both inside. The nutrient and/or the pest control substance can be time released.

The Cultivation Wall System Power & Data—The cultivation system operates on electrical power. The power source can be remote and/or local. The systems the electrical power operates includes at least one of: an irrigation system and an environmental control system. The power system also powers communication devices. The communication devices can communicatively couple to one of: other cultivation wall devices, a centralized processor, and remote client/s. The communication devices are coupled to at least one of: a sensing device, and output device and input device wherein the input and output device can be the same device.

The present power distribution configuration shows the power operating a processor that in turn operates the entire network of power consuming devices coupled to the plant cultivation wall. The processor operates on embedded code that can have several modules including operating the cultivation system's irrigation and environmental control. The processor with its controller is coupled to electromechanical devices operating the irrigation system. The devices can include a pump, a filter, an irradiating light source, and valved electronic faucets.

The processor can be coupled to an array of sensing devices serving both the irrigation system and the environmental controls. The sensing devices can include at least one of: a temperature sensor, a microphone, a moisture sensor, a barometric pressure sensor, an occupancy/motion sensor, a wind velocity sensor, a camera, a vibration sensor, a pressure sensor, a PH sensor, and a noise sensor.

The processor can be coupled to at least one of an output device including: a light source, a sound cancellation emitter, a sound emitting device, a transceiver, an electronic lock, and a power storage device.

The processor can operate on its code embedded operational parameters with real time sensed input received from onboard devices and/or input received from a remote source/s. The processor can communicate across the network of power consuming electronic devices by wire and/or wirelessly wherein at least one of the devices has a unique address.

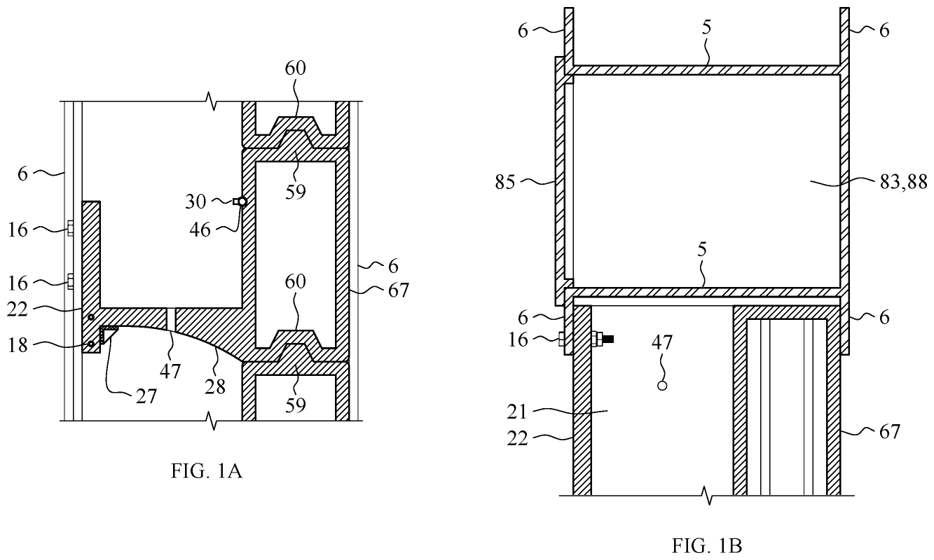

FIGS. 1A and 1B show a transverse and a partial longitudinal section of the planter shelf with a planter channel coupled unitarily to a wall panel.

FIG. 1A shows a transverse section of the planter shelf 20 unitarily coupled to a wall panel 67. The planter shelf 20 configured to retain plant material 43 has a “U” profile. The shelf's elements are comprised of the shelf web 21 disposed at the bottom of the “U” shaped profile unitarily coupled to the wall panel 67 on one side and to the planter shelf 20 on the other side. The planter channel 45, open to the above, extends continuously from one end of the planter shelf 20 unitary coupled to the wall panel 67 to the other end.

The planter's shelf 20 web referred to herein also as the web channel 45 is populated with weep holes 47 spaced apart at a repeated increment along the web's 21 longitudinal axis. The weep holes 47 are configured to remove excess fluid from the web channel 45. For structural reasons, the web 21 profile has variable depth wherein the section that couples to the wall panel 67 shows the greatest depth. The design of the web 21 profile configures the weight of the shelf 20 and the plant material 43 retained inside the shelf 20.

The present embodiment shows the web 21 having a curvilinear profile. The curvilinear profile also serves as a reflector 28 reflecting light emitted from a light source 27 coupled to the interior side of the planter's flange 22 and/or the bottom side of the planter channel 45 web 21. In a different embodiment the profile depth can be uniform or can include a support bracket/s below (not shown). The bracket 7 can be segmented or continuous. The planter flange 22 conceals the plant root retaining matrix 73 from view, also providing structural support to the planter channel 45.

The vertically oriented flange 22 is unitarily coupled to the web 21. The bottom section of the flange 22 can extend below the web 21 as shown in the present figure. The interior surface of the flange 22 extending below the web 21 can then become a mounting surface for at least one continuous or segmented concealed light source 27.

In other embodiments, other IOT devices can be coupled to the light source 27 power or power and data conductors. At least one of the IOT devices can have dedicated conductors next to the light source 27 conductors. The conductors typically originate at the chase post 83 and can extend through posts' webs 5, across several sections of walls.

At the bottom of flange 22 at least one elongated high tensile strength reinforcement member can provide the planter shelf 20 additional support against deflection.

The planter shelf 20 web 21 is unitarily coupled to a wall panel 67. By coupling the planter's web 21 to the wall of the wall panel 67, the planter shelf 20 including the plant material 43 weight is distributed over a large, elongated contact area. Having a large contact surface area permits greater weight loading while having thinner wall thickness.

The wall panel 67 unitarily coupled to the planter shelf 20 can have at least one continuous recess. Inside the recesses, an elongated irrigation pipe 46 can extend from one end of the planter shelf 20 to the other. The irrigation pipe 46 can have emitters coupled directly or to tributary plant pipes 30 at a regulated spacing along the length of the planter shelf 20. In another embodiment, the irrigation pipe 46 can be disposed inside the web channel 21 (not shown).

FIG. 1B shows a partial top view horizontal section of the planter shelf 20 end. The section is cut through the planter flange 22, wall panel 67, and a chase post 83. The planter shelf 20 unitarily coupled to a wall panel 67 is shown wedged between the flanges 6 of the chase post 83. The planter shelf 20 unitarily coupled to the wall panel 67 is secured against rotation by two through bolts 16 coupling the chase flange 6 to the planter flange 22. The planter shelf 20 unitarily coupled to the wall panel 67 weight is conveyed to the wall panel 67 below and so on to the bottom base panel 70 (not shown) and from there to the terrain surface or to a support foundation.

In some applications (not shown) where an opening is called for between wall panels 67, the planter shelf 20 unitarily coupled to a wall panel 67 and/or any other wall panel 67 weight is supported by at least two brackets 7. The brackets 7 are coupled to at least one of the post flange/s 6 and/or post web 5.

FIG. 1B also shows the planter shelf 20 end removed from the chase post web 5. The clearance shown is to allow some tolerances of the chase post 83 and the planter shelf 20 through installation. Similarly, the planter shelf 20 flanges' bore 17 can be slotted for the same reason and also for allowing for thermal expansion (not shown).

The chase post 83 is shown having two webs 5 with each having two flanges 6 and two perpendicularly disposed and unitarily coupled walls together forming a volumetric enclosure. One of the walls has an access panel 85 through which electromechanical equipment can be installed and maintained inside the enclosure.

The electromechanical equipment housed inside the chase post 83 is for the vertical plant cultivation system's fluid irrigation and environmental control. As such, several devices including processing, control, communication, sensing, power generation and a storage device can be associated with environmental control. The environmental control equipment or devices can be housed or coupled to the chase post and can be integrated with the cultivation wall irrigation system's power consuming devices.

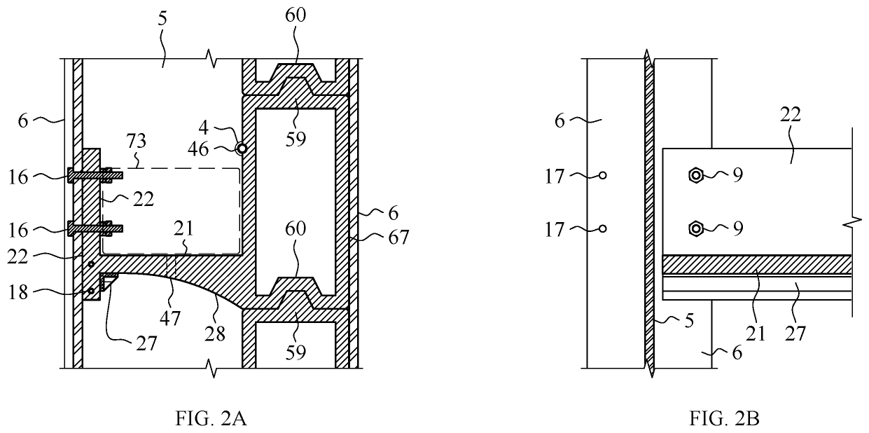

FIGS. 2A and 2B show a transverse and a partial vertical section of the planter shelf end in proximity to a post web.

FIG. 2A shows a transverse section through the chase post flanges 6, the planter shelf 20 unitarily coupled to the wall panel 67 and portion of wall panels 67 above and below. The section shows similar features as shown in FIG. 1A. The section cuts through the bolts 16 coupling the post web flanges 6 to the planter shelf flange 22. The shelf's irrigation pipe 46 is shown emerging from a bore in the chase web 4. The plant root support matrix 73 is shown in dashed line and so is a weep hole 47 disposed at the center of the planter channel web 21.

FIG. 2B shows a partial vertical section through the post's web 5 and the web of a planter channel 21. The flange 22 of the planter shelf 20 is shown coupled the post flange 6 by a pair of bolts 16 secured by bolt nuts 9. The bolts 16 secure the planter shelf 20 from rotational force and linear deflection. A continuous light source 27 is shown below the planter shelf web 21 with a reflector 28 aperture directing light toward the planter wall 67 it is facing.

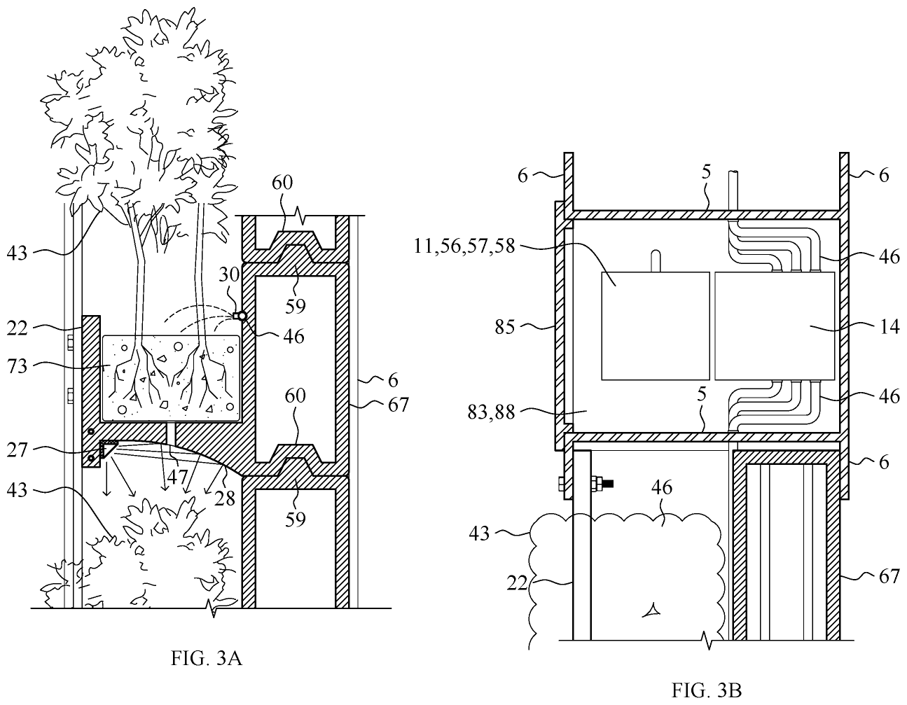

FIGS. 3A and 3B show a transverse and a partial horizontal section of the planter shelf with a planter channel coupled unitarily to a wall panel with plant material.

FIG. 3A shows a transverse section of the planter shelf 20 unitarily coupled to a wall panel 67. Inside the planter channel 25 a root retaining matrix 73 is shown disposed on the planter shelf web 21. A plurality of plants are shown growing from the matrix 73 with their roots embedded in the matrix 73 material. The matrix 73 material can be made of re-processed organic material and can retain its form over an extended duration. The matrix 73 may contain nutrients, pest repelling and other additives that are gradually released. The matrix 73 can be fabricated in a form of elongated bricks and can be delivered to the installation site without plant or seed, seeded and/or with at least one rooted plant. A planter irrigation pipe 30 coupled to the wall panel 67 is shown emitting fluid onto the matrix 73. The fluid emitted is absorbed by the matrix 73 with excess fluid evacuated through the weep hole 47 shown at the planter channel's web 21.

Below the web 21, a light source 27 coupled to at least one of: the interior face of the planter shelf flange 22 and the bottom face of the planter channel web 21 emits light onto the plants below and the wall panel 67. In the present figure, the bottom face of the planter channel 21 face has a parabolic reflector 28 profile that redirects transient light emitted downwardly on to the plant. The reflector's 28 reflective surface can be configured to have high reflectance value by means of at least one of: a film and an applied coat of high reflectance paint. Other power consuming devices can be coupled to the light source power conductor or can be disposed alongside having dedicated power or power and data conductors.

FIG. 3B shows a partial top view horizontal end section of the planter shelf 20 unitarily coupled to the wall panel 67 abutting a post chase 83 with plants disposed inside the planter shelf channel 45. The planter irrigation pipe 46 is shown coupled to the wall panel 67. The planter irrigation pipe 46 in FIG. 3B is shown to originate from inside the chase post 83. The pipes shown can be coupled to a manifold. The pipes exit the chase enclosure 88 from the opposing chase webs 5.

In this figure, the chase post enclosure 88 can retain the cultivation system's electromechanical key components including at least one of: a processor 56 driven by code with resident memory, a controller 57, a transceiver 61, a power generation device/storage device 52, a pump 11, a valve 48, a switching device 101, a security alarm 96, a camera 34 and other output device/s. IOT devices can be housed or coupled to the chase post 83 and can be coupled mechanically and/or electrically to elements coupled to or housed in the chase post 83.

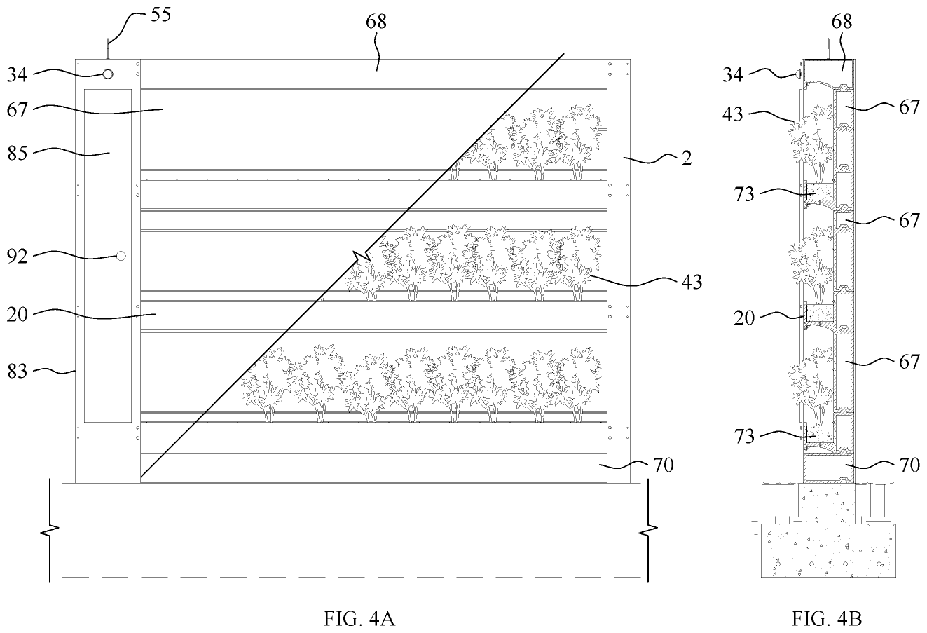

FIGS. 4A and 4B show an elevation view and a traverse section view of the cultivation wall with the planter shelf configured to retain plants in a web channel.

FIG. 4A shows a section of the vertical plant cultivation wall with three planter shelves 20 spaced apart above one another. A section line divides the vertical plant cultivation wall of FIG. 4A into two areas where one area shows plants growing out of the planter shelves 20 and the other with none. The planter shelves 20 are unitarily coupled to wall panels 67. This novel assembly is used with stand-alone wall panels disposed between said planter panels together forming the vertical cultivation wall.

At the top of the wall, a header panel 68 encloses the walled assembly. The header panel 68 can retain mechanical and electrical devices as well as store and/or convey fluid. At the bottom of the wall, the base panel 70 shown supports at least a portion of the weight of the cultivation wall assembly resting on it from above. The base panel 70 also provides protection from flooding and damage from maintenance service equipment. The base panel 70 can be hollow or can store fluid. Where the terrain is rocky and/or difficult to excavate, at least one of: power, data and fluid circulation can be conveyed through the base panel 70. The power, data and fluid can then flow to and from neighboring wall sections through the web 5 of the post 2, 83 located at both sides of the cultivation wall.

The wall assembly illustrated in FIG. 4A shows a chase post 83 at one side of the wall and a post 2 on the other side wherein the wall panels 67 are wedged at their end between the posts' flanges 6. The chase post 83 elements shown include an access panel 85, a camera 34, an antenna 55, and a tamperproof lock 92. The entire wall assembly wedged between or wedged between and coupled to posts 2, 83 rest on a foundation shown in dashed line. In an alternate application the posts 2, 83 can be embedded in the soil.

FIG. 4A illustrates a chase post 83 on one end of the cultivation wall and a post 2 on the other end of the cultivation wall. The modular cultivation wall length is unlimited. The chase post 83 can provide plants fluid over at least 500 feet. Therefore one can plan to have a single chase post 83 that provides for the cultivation wall system extending the distance of at least 1000 feet.

FIG. 4B shows a transverse cross-section of the vertical cultivation wall. At the top, a header post 68 encloses the wall assembly. The header post 68 rests at least in part on several wall panels 67. Several of the panels are standalone wall panels while the others are wall panels unitarily coupled to planter shelves 20. Together the assembly rests at least in part on the base panel 70 that distributes the load to the terrain below. The wall panels' 67 height shown vary, demonstrating the walled system's dimensional flexibility. In addition, the height and width of the planter shelves can vary as well (not shown).

FIG. 4B illustrates a foundation supporting the wall assembly. In other applications, the assembly's posts 2, 83 can be anchored to a foundation only while the base panel 70 transfer the above loads to the ground. In yet another example, the posts 2, 83 can be embedded in the ground. Elements shown in FIG. 4B include an antenna 55 on top of the wall assembly, plant material disposed inside the plant root retaining matrix 73, and a camera 34.

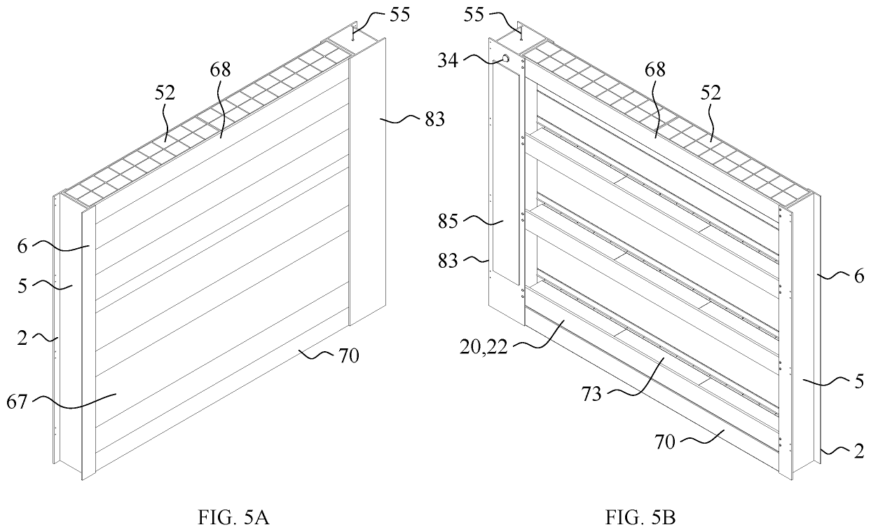

FIGS. 5A and 5B show perspective views of the back and front elevations of the vertical cultivation wall system comprised of posts and plant shelves unitarily coupled to wall panels and standalone wall panels.

FIG. 5A shows in perspective view the back side of a wall section assembly. The modular wall assembly is comprised of a plurality of wall panels 67, disposed between a chase post 83 and a post 2 wedged within the post's flanges 6. The wall panels 67 are vertically disposed between a header panel 68 above and a base panel 70 below. On the header panel 68, a plurality of photovoltaic power generating panels 52 are disposed. At the top of the chase post 83, an antenna 55 is communicatively coupled to the electronic equipment disposed inside the chase post enclosure 88 with at least one of: a device coupled to the cultivation wall and to a remote device.

The wall assembly rests on the base panel 70. The base panel 70 transfers at least a portion of the assembly weight to the terrain below. The terrain can be the ground, or a continuous linear foundation configured to receive a portion or the entire weight of the wall assembly.

FIG. 5B shows in perspective view the front elevation of the wall assembly. The modular wall assembly is comprised of a plurality of planter shelves 20 unitarily coupled to wall panels 67 and standalone wall panels 67 wherein the planter shelves 20 are horizontally oriented and vertically spaced apart having the standalone panels 67 coupled to the planter panels 67 from above and below together forming the wall. At the top of the wall a header panel 68 secures the wall assembly from above against uplift forces. At the bottom, the wall assembly rests on the base panel 70. The base panel 70 transfers at least a portion of the wall assembly weight to the terrain below.

The wall assembly is disposed between two posts—a chase post 83 and a post 2. The wall panels' 67 ends are wedged between the posts' 2, 83 flanges 6 wherein the flange 21 of the panels coupled to the planter shelves 20 are mechanically coupled to at least the flanges of the posts 2, 83. The figure's elements include a photovoltaic power generating panel 52 disposed on the header panel 68, an antenna 55 on top of the chase post 83, a camera 34 coupled to the chase post wall on the access panel 85 side, plant root retaining matrix 73 inside the planter shelves 20, and a base panel 70 at the bottom of the modular wall assembly.

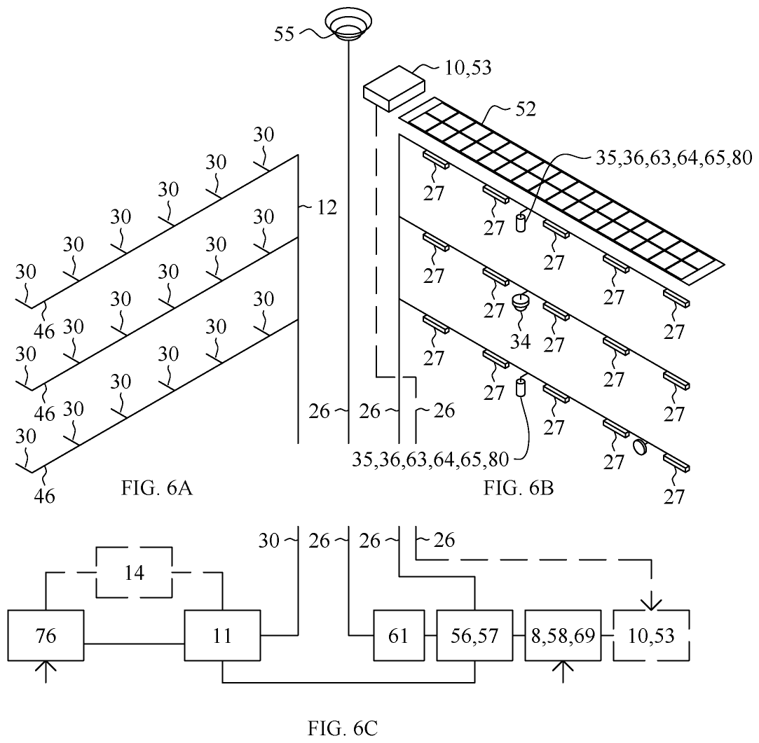

FIG. 6A shows a diagram of the vertical cultivation system's fluid circulatory system and electrical power circulation network of coupled devices.

FIG. 6A shows a fluid pipe 12 conveying fluid to the irrigation pipe 46. From the irrigation pipe 46 the fluid is distributed to the plant irrigation pipe 30. From the plant irrigation pipe 30 the fluid is emitted onto the plants. The nozzle 51 of the plant irrigation pipe 30 can be open or can be coupled to a drip emitter. One or more parts of the fluid irrigation system, such as, but not limited to, the fluid irrigation pipe 46, can be coupled to the planter shelf and/or the wall.

The fluid irrigation pipe 12 can convey the fluid to a container or a mixing tank 14 or directly to the irrigation pipe 46. The fluid can be flowing by gravity and/or under pressure. In FIG. 3B the irrigation pipes 46 are shown coupled to a container/mixing tank 14. Each of the irrigation pipes 46 can be coupled to an electronic valved faucet 48 (not shown) controlled by the irrigation system controller 57. For example, fluid can be circulated by the pump 11 into the container or mixing tank 14 being filtered along the way. The container tank 14 may be pressurized with the system's processor 56 directing the controller 57 to open specific addressable valved faucets 48 to open for a specified duration.

In another example the fluid irrigation pipes 46 are kept fluid free until the time the plants need to be irrigated. The cultivation system pump 11 can be configured to force air throughout the planter shelves' 20 fluid irrigation network. Such a practice can be embraced in geographical locations where the temperature often dips below freezing.

FIG. 6B shows an example of the cultivation wall system network of power consuming devices. Line power 26 is shown conveying power or power and data to a plurality of devices coupled to the cultivation system wall (the wall not shown). The devices include input, output, communication, and sensing devices. The devices shown include a camera 34, a transceiver antenna 55, a light source 27, a speaker 35, a humidity sensor 36, an occupancy sensor 63, a temperature sensor 64, a parameter security sensor 65, and a noise cancellation device 80. Other devices shown include a back-up power/power storage device 10 and an inverter 53. The inverter can be coupled to a power generating device 52 such as photovoltaic panels. The power distribution system can be wired or wirelessly coupled to local networked devices as well as remote members.

FIG. 6C shows the plant cultivation system governed by at least one master processor 56. The processor 56 can direct the operation of all power consuming devices of the fluid circulation system and other devices not directly related to the fluid irrigation system. Aside from the code operated processor 56, the system can include a controller 57, a communication module 61, a power storage device/backup power 10, an inverter 53, and a power generating device 52.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

Element List

| | |
|---|---|
| 1. | Vertical planter system |
| 2. | Post |
| 3. | |
| 4. | Post web bore |
| 5. | Post web |
| 6. | Post flange |
| 7. | Bracket |
| 8. | |
| 9. | Bolt nut |
| 10. | Back-up power storage device |
| 11. | Pump |
| 12. | Fluid pipe |
| 13. | Power and data conduit |
| 14. | Container/mixing tank |
| 15. | Shelf bracket |
| 16. | Bolt |
| 17. | Bore |
| 18. | Tensile reinforcement |
| 19. | Bolts |
| 20. | Planter shelf |
| 21. | Shelf web |
| 22. | Shelf flange |
| 23. | Plant vessel opening |
| 24. | Web bridge |
| 25. | “T” junction |
| 26. | Line power |
| 27. | Light source |
| 28. | Reflector |
| 29. | Power/data protrusion |
| 30. | Irrigation pipe |
| 31. | Protrusion panel |
| 32. | Grooves/channel |
| 33. | |
| 34. | Camera |
| 35. | Speaker |
| 36. | Humidity sensor |
| 37. | |
| 38. | |
| 39. | Cross bar |
| 40. | Cross bar bore |
| 41. | |
| 42. | Plant vessel irrigation aperture |
| 43. | Plant material |
| 44. | |
| 45. | Planter channel |
| 46. | Irrigation pipe |
| 47. | Moisture evacuation outlet/weep hole |
| 48. | Valved faucet |
| 49. | |
| 50. | Planter vessel |
| 51. | Pipe nozzle |
| 52. | Photovoltaic panel/power generating device |
| 53. | Inverter |
| 54. | Driver |
| 55. | Antenna |
| 56. | Processor |
| 57. | Controller |
| 58. | Power storage device |
| 59. | Wall keyed protrusion |
| 60. | Wall keyed channel |
| 61. | Wireless device/communication module |
| 62. | Microphone |
| 63. | Occupancy sensor |
| 64. | Temperature sensor |
| 65. | Perimeter security sensor |
| 66. | Tarp |
| 67. | Wall panel |
| 68. | Header panel |
| 69. | Power supply |
| 70. | Base panel |
| 71. | |
| 72. | Partition protrusion |
| 73. | Root retaining medium/matrix |
| 74. | Other enclosure/tarp housing |
| 75. | Stiffener |
| 76. | |
| 77. | Attenuation wall/panel |
| 78. | Sound attenuation panel |
| 79. | Sound cancellation device |
| 80. | Noise cancellation device |
| 81. | Security fence |
| 82. | |
| 83. | Chase post |
| 84. | Post's wall |
| 85. | Chase access panel |
| 86. | |
| 87. | Side flange/bracket flange |
| 88. | Chase post enclosure |
| 89. | Access panel |
| 90. | |
| 91. | Chase outward wall |
| 92. | Tamper-proof lock |
| 93. | |
| 94. | |
| 95. | Fluid circulation system |
| 96. | Security alarm |
| 97. | Sensing device |
| 98. | Communication device |
| 99. | Cultivation system power |
| 100. | Fluid |

1. A modular vertical cultivation wall system comprising:
at least two vertical posts, at least one planter shelf including a planter flange and a planter web, and a plurality of wall panels, wherein each of the at least two vertical posts is anchored and includes a post web and at least one post flange coupled thereto, wherein
the at least one planter shelf is coupled to one of a plurality of wall panels, and is horizontally disposed,
wherein
the at least one planter shelf extends between the at least two vertical posts,
wherein
at least one of the plurality of wall panels is disposed above and coupled to another one of the plurality of wall panels, and at least one of the planter flange and the planter web is coupled to at least one of: the post web and the at least one post flange.

2. The system of claim 1, further comprising a continuous power conductor including at least one lighting source coupled to the at least one planter shelf.

3. The system of claim 1, further comprising a high tensile strength reinforcement member coupled to the planter flange.

4. The system of claim 1, wherein a mounting height of the at least one planter shelf is adjustable along a vertical height of at least one of: the post web and the at least one post flange.

5. The system of claim 1, wherein at least one of: one of the at least two vertical posts, the at least one planter shelf, and a first wall panel of the plurality is coupled to at least one of: a fluid conveyance device, a power generating device, a sensing device, a communication device, an output device, and an input device.

6. The system of claim 1, further comprising a wall panel enclosure coupled to the at least one planter shelf, wherein the enclosure is configured to receive at least one of: a gas, a liquid, and a solid material.

7. The system of claim 1, wherein a chase post includes at least two chase post webs, at least two chase post flanges extending outward from one side of the chase post web, and an access panel.

8. The system of claim 7, wherein the chase post is configured to house at least one of: a fluid storage device, a fluid circulation device, and an electrical power consuming device.

9. The system of claim 1, wherein at least one of the plurality of wall panels is configured to attenuate sound transmission by at least one of: material fill inside the wall and vacuum seal of the wall interior.

10. The system of claim 1, wherein at least one of the plurality of wall panels is coupled to the at least one planter shelf and is coupled to and disposed above and/or below another one of the plurality of wall panels.

11. The system of claim 1, wherein at least one mechanical fastening device couples the planter flange and/or the planter web to the at least one post flange and/or the post web.

12. The system of claim 1, wherein a fluid irrigation pipe extends along a length of the planter shelf coupled to at least one of: the inside, top or bottom of a planter channel, and to the wall panel.

13. A modular vertical cultivation wall system comprising:
at least two vertical posts, at least one planter shelf, and a plurality of wall panels, wherein each of the vertical posts is anchored using at least one post web and one post flange, wherein each post web and post flange is/are unitarily coupled, wherein at least one planter shelf is unitarily coupled to a wall panel, wherein the at least one planter shelf unitarily coupled to the wall panel is horizontally disposed, wherein each end of the at least one planter shelf extends between the post flanges, wherein one of a plurality of wall panels is coupled from above to another one of the plurality of wall panels, wherein a second wall panel is coupled from below to the same wall panel with the unitarily coupled a planter shelf, wherein a planter web and/or a planter flange of the planter shelf is/are coupled to at least one support bracket and, the support bracket being coupled to at least one of: the post flange and the post web.

14. The system of claim 13, further comprising a continuous power conductor including at least one lighting source coupled to the at least one planter shelf.

15. The system of claim 13, further comprising a high tensile strength reinforcement member coupled to the planter flange.

16. The system of claim 13, wherein a mounting height of the at least one planter shelf is adjustable along a vertical height of at least one of: the post web and the post flange.

17. The system of claim 13, wherein at least one of the post and the at least one planter shelf is coupled to at least one of a power generating device, a sensing device, a communication device, an output device, and an input device.

18. The system of claim 13, further comprising wall panel enclosure unitarily coupled to the planter shelf wherein inside the enclosure there is at least one of: a gas, a liquid, a solid and a vacuum.

19. The system of claim 13, wherein a chase post has at least two chase post webs, at least two chase post flanges extending outward from one side of the chase post web, and an access panel.

20. The system of claim 19, wherein the chase post is configured to house at least one of: a fluid storage device, a fluid circulation device, and an electrical power consuming device.

21. The system of claim 13, wherein at least one of the plurality of wall panels is configured to attenuate sound transmission.

22. The system of claim 13, wherein at least one wall panel unitarily coupled to a planter shelf is coupled to and disposed above and/or below a wall panel.

23. The system of claim 13, wherein a plant matrix is disposed on the web of the planter shelf.

24. The system of claim 13, wherein the fluid flowing through a fluid irrigation pipe that extends along a length of a planter channel and across the post web to at least one additional planter shelf.
